(19) United States
(12) Patent Application Publication
(10) Pub. No.: US 2017/0179537 A1
(43) Pub. Date: Jun. 22, 2017

(54) SODIUM MOLTEN SALT BATTERY

(71) Applicant: Sumitomo Electric Industries, Ltd., Osaka-shi (JP)

(72) Inventors: Shoichiro Sakai, Osaka-shi (JP); Koji Nitta, Osaka-shi (JP); Atsushi Fukunaga, Osaka-shi (JP); Koma Numata, Osaka-shi (JP); Eiko Imazaki, Osaka-shi (JP)

(73) Assignee: Sumitomo Electric Industries, Ltd., Osaka-shi (JP)

(21) Appl. No.: 15/118,377

(22) PCT Filed: Jun. 12, 2014
(86) PCT No.: PCT/JP2014/065535

§ 371 Date: Aug. 11, 2016

(30) Foreign Application Priority Data
Feb. 13, 2014 (JP) 2014-025562

(51) Int. Cl. H01M 10/39; H01M 4/587; H01M 4/133

(52) U.S. Cl. CPC H01M 10/399; H01M 4/133; H01M 4/587; H01M 2300/0048; H01M 2004/027

(57) ABSTRACT

A sodium molten salt battery includes a positive electrode containing a positive electrode active material, a negative electrode containing a negative electrode active material, a separator provided between the positive electrode and the negative electrode, and a molten salt electrolyte having sodium ion conductivity, in which the negative electrode active material contains hard carbon and is pre-doped with sodium ions, and in which when the state of charge is 0%, the potential of the negative electrode is 0.7 V or less with respect to metallic sodium.

### TECHNICAL FIELD

The present invention relates to a sodium molten salt battery and improvement in a negative electrode of a sodium molten salt battery.

### BACKGROUND ART

In recent years, techniques for converting natural energy, such as sunlight and wind power, into electrical energy have been receiving attention. There has been increasing demand for lithium ion secondary batteries, lithium ion capacitors, and so forth as electricity storage devices capable of storing a large amount of electrical energy.

However, the price of lithium resources is rising in association with the expansion of the market for electricity storage devices.

Electricity storage devices including sodium ions have been studied. PTL 1 discloses a sodium ion capacitor including the combination of a polarizable positive electrode and a negative electrode containing, for example, hard carbon. In PTL 1, from the viewpoint of improving the discharge capacity or the cycle properties, the negative electrode is pre-doped with sodium ions.

However, in lithium ion secondary batteries and sodium ion capacitors, the heat resistance is low, and electrolytes are easily decomposed on surfaces of electrodes because of the use of organic electrolytic solutions (organic solvent solution of supporting electrolytes). There have been advances in the development of molten salt batteries including flame-retardant molten salts serving as electrolytes. Molten salts have excellent thermal stability, relatively easily ensure safety, and are also suited for continuous use at high temperatures. A molten salt battery can include a molten salt which contains cations of an inexpensive alkali metal (in particular, sodium) other than lithium and which is used as an electrolyte, so that the production cost is low.

### CITATION LIST

### Patent Literature

PTL 1: Japanese Unexamined Patent Application Publication No. 2012-69894

### SUMMARY OF INVENTION

### Technical Problem

In a molten salt battery including a sodium-ion-conductive molten salt electrolyte (sodium molten salt battery), hard carbon is used as a negative electrode active material. Hard carbon is less likely to deteriorate because of only a small change in volume due to charging and discharging, compared with graphite used as a negative electrode active material in lithium ion secondary batteries. This provides a long cycle life. However, in addition to a large irreversible capacity of hard carbon, when hard carbon is used for a negative electrode, a battery voltage is not stable. It is thus difficult to maintain a high voltage from the beginning to the end of discharge.

In the sodium ion capacitor in PTL 1, when a negative electrode having a large irreversible capacity is used, the negative electrode is pre-doped with sodium ions from the viewpoint of improving the discharge capacity or the cycle properties. However, the charge-discharge curve of the sodium ion capacitor differs from that of a sodium molten salt battery even if the same hard carbon is used for negative electrodes. It is thus difficult to grasp the behavior of the battery voltage of a sodium molten salt battery from PTL 1.

There is provided a sodium molten salt battery in which the battery voltage (or battery capacity) during charging and discharging is stable even when hard carbon is used as a negative electrode active material.

### Solution to Problem

An aspect of the present invention relates to a sodium molten salt battery including a positive electrode containing a positive electrode active material, a negative electrode containing a negative electrode active material, a separator provided between the positive electrode and the negative electrode, and a molten salt electrolyte having sodium ion conductivity, in which the negative electrode active material contains hard carbon and is pre-doped with sodium ions, and in which when the state of charge (SOC) is 0%, the potential of the negative electrode is 0.7 V or less with respect to metallic sodium.

### Advantageous Effects of Invention

According to the foregoing aspect of the present invention, in the sodium molten salt battery, the battery voltage (and/or battery capacity) during charging and discharging is stable even when hard carbon is used as a negative electrode active material.

### BRIEF DESCRIPTION OF DRAWINGS

FIG. 1 is a longitudinal sectional view schematically illustrating a sodium molten salt battery according to an embodiment of the present invention.

FIG. 2 is a block diagram schematically illustrating a charge-discharge system according to an embodiment of the present invention.

FIG. 3 illustrates charge-discharge curves of sodium molten salt batteries A1 and A2 of examples during the first charge-discharge cycle.

FIG. 4 illustrates charge-discharge curves of sodium molten salt batteries A3 and A4 of examples during the first charge-discharge cycle.

FIG. 5 illustrates charge-discharge curves of sodium molten salt batteries B1 and B2 of comparative examples during the first charge-discharge cycle.

FIG. 6 illustrates exemplary charge-discharge curves of a sodium molten salt battery (half cell) including a negative electrode containing hard carbon serving as a negative electrode active material.

### DESCRIPTION OF EMBODIMENTS

### Description of Embodiments of Invention

First, embodiments of the present invention will be listed and described below.

An embodiment of the present invention relates to (1) a sodium molten salt battery including a positive electrode containing a positive electrode active material, a negative electrode containing a negative electrode active material, a separator provided between the positive electrode and the negative electrode, and a molten salt electrolyte having sodium ion conductivity, in which the negative electrode active material contains hard carbon and is pre-doped with sodium ions, and when the state of charge (SOC) is 0%, the potential of the negative electrode is 0.7 V or less with respect to metallic sodium.

Hard carbon is less likely to deteriorate because of only a small change in volume due to charging and discharging. This provides a long cycle life. However, when hard carbon is used for a negative electrode, a battery voltage (and/or capacity) is not stable. When hard carbon is used as a negative electrode active material, the voltage or the capacity of a battery is required to be stabilized with a peripheral device, thus increasing the cost. For this reason, substantially no negative electrode containing a negative electrode active material composed of hard carbon is practically used in a lithium ion secondary battery.

In a sodium molten salt battery, hard carbon is used as a negative electrode active material. A charge-discharge curve in the case of hard carbon has only a few flat portions of the voltage, and the voltage decreases in a nearly linear manner. That is, ions are intercalated into hard carbon at various voltages. The effect of impurities is large. It is thus difficult to stabilize the voltage (and/or capacity) of the battery. In the sodium molten salt battery, the amount of ions in an electrolyte is large, compared with batteries including organic electrolytic solutions. Thus, cations other than sodium ions can be intercalated into hard carbon to allow a side reaction to occur easily during charging and discharging. Thus, it is further difficult to stabilize the battery (and/or capacity) of the battery. The sodium molten salt battery can be operated at a high temperature, compared with batteries including organic electrolytic solutions. A higher operating temperature of the battery is more likely to cause a side reaction, such as the decomposition of the molten salt electrolyte, to occur even if a molten salt electrolyte is used, so that a decomposition product can be intercalated into hard carbon.

In the foregoing embodiment of the present invention, the negative electrode active material containing hard carbon is pre-doped with sodium ions in such a manner that the potential of the negative electrode is 0.7 V or less at a SOC of 0% with respect to metallic sodium. Thus, charging and discharging are less likely to be performed in a voltage range where charging and discharging are liable to be unstable (that is, a voltage range where the effect of impurities and/or cations other than sodium ions is large). In other words, a voltage range where the battery voltage is relatively flat and where a side reaction due to charging or discharging is less likely to occur can be used for charging and discharging. This stabilizes the voltage of the battery to stabilize the capacity of the battery. When the pre-doping of sodium ions is performed in such a manner that the potential of the negative electrode is 0.7 V or less, the negative electrode active material is pre-doped with sodium ions in an amount more than the irreversible capacity. This results in an increase in the operation voltage of the battery and maintains a high capacity maintenance ratio even if charging and discharging are repeated (that is, improves the cycle properties).

The potential of the negative electrode with respect to metallic sodium is based on a value when the state of charge (SOC) of the sodium molten salt battery is 0%. The state in which SOC is 0% indicates a state in which discharging is performed to the discharge cut-off voltage of the sodium molten salt battery (that is, a completely discharged state). The discharge cut-off voltage is one of the battery characteristics of the sodium molten salt battery set by a manufacturer. The discharge cut-off voltage may be appropriately set in the range of, for example, 1.0 to 2.5 V. The sodium molten salt battery is usually controlled by a voltage control circuit of an apparatus on which the battery is mounted, so as not to be discharged to a voltage lower than the discharge cut-off voltage set.

The molten salt battery used here indicates a battery including a molten salt electrolyte. The molten salt electrolyte indicates an electrolyte mainly containing an ionic liquid. The ionic liquid is the same as a salt in a molten state (molten salt) and a liquid ionic substance composed of anions and cations. The sodium molten salt battery indicates a battery which includes a molten salt exhibiting sodium ion conductivity as an electrolyte and in which sodium ions serve as charge carriers participating in a charge-discharge reaction.

(2) The molten salt electrolyte preferably contains 80% by mass or more of an ionic liquid. The molten salt electrolyte has high heat resistance and/or high flame retardancy. Thus, the battery is operated more stably even if the operating temperature of the battery.

(3) When SOC is 0%, the pre-doping amount of the sodium ions (hereinafter, also referred to simply as a “pre-doping amount”) is preferably 6 parts by mass or more with respect to 100 parts by mass of the negative electrode active material. When the pre-doping amount in the negative electrode active material is within the range, it is possible to further stabilize the voltage and the capacity of the battery.

(4) When SOC is 0%, the potential of the negative electrode is preferably 0.3 V or less with respect to metallic sodium. (5) When the state of charge is 0%, the pre-doping amount of the sodium ions is equal to or more than twice the irreversible capacity of the negative electrode active material. In these cases, the effects of stabilizing the voltage and the capacity the battery are further enhanced.

(6) The ionic liquid preferably contains a first salt of sodium ions and bis(sulfonyl)amide anions and a second salt of an organic cations and bis(sulfonyl)amide anions. The molten salt electrolyte has sodium ion conductivity and contains the first salt and the second salt, so that the battery can be operated at a relatively low temperature.

The organic cations have lower heat resistance than that of inorganic cations and thus can be decomposed to form a decomposition product at a higher operating temperature of the sodium molten salt battery. The organic cations and/or a decomposition product thereof is irreversibly reacted with hard carbon, depending on the potential of the negative electrode, thereby failing to increase the voltage of the battery and reducing the capacity of the battery. In an embodiment of the present invention, the potential of the negative electrode is reduced by the pre-doping of sodium ions. Thus, even when the molten salt electrolyte contains the organic cations, charging and discharging are performed in a voltage range where a side reaction due to charging or discharging is less likely to occur. This inhibits reductions in the voltage and the capacity of the battery and more effectively stabilizes the voltage and the capacity of the battery.

(7) The ratio of the reversible capacity of the negative electrode to the reversible capacity of the positive electrode, i.e., Cₙ/Cₚ, is preferably in the range of 0.85 to 2.8. (8) The ratio of the reversible capacity of the negative electrode to the reversible capacity of the positive electrode, i.e., Cₙ/Cₚ, is more preferably in the range of 1.4 to 2.5. A higher Cₙ/Cₚ ratio is more likely to lead to a reduction in the operating voltage of the battery. However, when the pre-doping of sodium ions is performed in such a manner that the potential of the negative electrode is 0.7 V or less, a reduction in the operating voltage of the battery is inhibited even at a high Cₙ/Cₚ ratio. When the Cₙ/Cₚ ratio is within the range described above, the deposition of metallic sodium on a surface of the negative electrode is inhibited during overcharging, normal operation, high-rate charging, and so forth. Furthermore, the local deposition of metallic sodium on edge portions and so forth of hard carbon is inhibited, thereby inhibiting the detachment of metallic sodium deposited. This improves the safety and/or the cycle properties of the battery.

### Details of Embodiments of Invention

Specific examples of a molten salt battery according to embodiments of the present invention will be described below with appropriate reference to the drawings. The present invention is not limited to these examples. The present invention is indicated by the appended claims. It is intended to include any modifications within the scope and meaning equivalent to the scope of the claims.

### (Negative Electrode)

A negative electrode contains a negative electrode active material containing hard carbon. Specifically, the negative electrode may include a negative electrode current collector and a negative electrode mixture (or a negative electrode mixture layer) which is immobilized on the negative electrode current collector and which contains the negative electrode active material.

As the negative electrode current collector, for example, metal foil, a nonwoven fabric composed of metal fibers, and/or a porous metal sheet is used. Examples of a metal preferably contained in the negative electrode current collector include, but are not limited to, copper, copper alloys, nickel, nickel alloys, aluminum, and aluminum alloys because they are not alloyed with sodium and are stable at a potential of the negative electrode.

The metal foil used for the negative electrode current collector has a thickness of, for example, 10 to 50 μm. The nonwoven fabric composed of metal fibers or the porous metal sheet has a thickness of, for example, 100 to 1000 μm.

Unlike graphite, which has a graphite crystal structure in which carbon layer planes are stacked in layers, hard carbon, serving as a negative electrode active material, has a turbostratic structure in which carbon layer planes are stacked in a state of being three-dimensionally displaced. The heat treatment of hard carbon even at a high temperature (e.g., 3000° C.) does not result in a transformation from the turbostratic structure to the graphitic structure or the development of graphite crystallites. Thus, hard carbon is also referred to as non-graphitizable carbon.

The average interplanar spacing d₀₀₂ of the (002) planes of a carbonaceous material measured from an X-ray diffraction spectrum is used as an index to the degree of development of a graphite crystal structure of the carbonaceous material. The carbonaceous material categorized into graphite typically has a small average interplanar spacing d₀₀₂ less than 0.337 nm. In contrast, the hard carbon with the turbostratic structure has a large average interplanar spacing d₀₀₂ of, for example, 0.37 nm or more and preferably 0.38 nm or more. The upper limit of the average interplanar spacing d₀₀₂ of the hard carbon is not particularly limited. The average interplanar spacing d₀₀₂ may be, for example, 0.42 nm or less. The hard carbon may have an average interplanar spacing d₀₀₂ of, for example, 0.37 to 0.42 nm and preferably 0.38 to 0.4 nm.

In lithium ion secondary batteries, graphite is used for negative electrodes. Lithium ions are intercalated into interlayer portions of the graphite crystal structure in graphite (specifically, the layered structure of carbon layer planes (what is called a graphene structure)). The hard carbon has the turbostratic structure. The proportion of the graphite crystal structure in the hard carbon is small. In the case where sodium ions are occluded in the hard carbon, sodium ions enter the turbostratic structure of the hard carbon (specifically, portions other than interlayer portions of the graphite crystal structure) and are adsorbed on the hard carbon, so that sodium ions are occluded in the hard carbon. Examples of the portions other than the interlayer portions of the graphite crystal structure include voids (or pores) formed in the turbostratic structure.

In lithium ion secondary batteries, many lithium ions are intercalated into and deintercalated from interlayer portions of the layered structure of graphite during charging and discharging. In addition, the proportion of a layered structure is large. Thus, a change in the volume of an active material due to charging and discharging is large. The repetition of charging and discharging significantly degrades the active material. In sodium molten salt batteries, sodium ions are inserted into and released from the voids and so forth in the turbostratic structure. Thus, a stress caused by the insertion and release of sodium ions is relieved to reduce a change in volume, thus inhibiting the degradation even if the charging and discharging are repeated.

Regarding the structure of hard carbon, various models have been reported. It is considered that in the turbostratic structure, carbon layer planes are stacked in a state of being three-dimensionally displaced to form voids as described above. In the case where the molten salt electrolyte contains impurities, the impurities are irreversibly occluded in the voids and/or the interlayer portions of the layered structure, so that the capacity of the negative electrode can be irreversibly reduced. In particular, the size of the voids is sometimes larger than that of the interlayer portions of the layered structure. The molten salt electrolyte contains a large amount of ions. Thus, in the case where impurities and/or cations other than sodium ions are contained in the molten salt electrolyte, they are seemingly liable to affect the molten salt electrolyte.

The hard carbon has the voids (or pores) as described above and thus has a low average specific gravity, compared with graphite having a crystal structure in which carbon layer planes are densely stacked in layers. Graphite has an average specific gravity of about 2.1 to about 2.25 g/cm³. The hard carbon has an average specific gravity of, for example, 1.7 g/cm³ or less and preferably 1.4 to 1.7 g/cm³ or 1.5 to 1.7 g/cm³. The average specific gravity of the hard carbon leads to only a small change in volume due to the occlusion and release of sodium ions during charging and discharging, thus the degradation of the active material is effectively inhibited.

The hard carbon has an average particle size (a particle size at a cumulative volume of 50% in the volume particle size distribution) of, for example, 3 to 20 μm and preferably 5 to 15 μm. In the case where the average particle size is within the range described above, the filling properties of the negative electrode active material in the negative electrode is easily improved.

The hard carbon includes a carbonaceous material obtained by, for example, carbonization of a raw material in a solid state. The raw material subjected to carbonization in the solid state is a solid organic substance. Specific examples thereof include saccharides and resins (thermosetting resins, such as phenolic resins, and thermoplastic resins, such as polyvinylidene chloride. Examples of saccharides include saccharides having relatively short carbohydrate chains (monosaccharides, such as sucrose); and polysaccharides, such as cellulose [for example, cellulose and derivatives thereof (cellulose esters, cellulose ethers, and so forth), and cellulose-containing materials, such as wood and fruit shells (coconut shells and so forth)]. Glassy carbon is also included in the hard carbon. A single type of hard carbon may be used alone. Two or more types of hard carbon may be used in combination.

The negative electrode active material is not particularly limited as long as it contains the hard carbon. The negative electrode active material may contain a material which is other than the hard carbon and which reversibly occludes and release sodium ions. The negative electrode active material has a hard carbon content of, for example, 90% by mass or more and preferably 95% by mass or more. It is also preferable to use the hard carbon alone as the negative electrode active material.

In an embodiment of the present invention, by pre-doping the negative electrode active material with sodium ions, the potential of the negative electrode at a SOC of 0% is reduced. This results in increases in the operating voltage and the capacity of the sodium molten salt battery. The potential of the negative electrode pre-doped with sodium ions is 0.7 V or less, preferably 0.6 V or less, more preferably 0.3 V or less, and particularly preferably 0.1 V or less at a SOC of 0% with respect to metallic sodium. The lower limit of the potential of the negative electrode pre-doped with sodium ions at a SOC of 0% is not particularly limited and is, for example, 0.01 V or more.

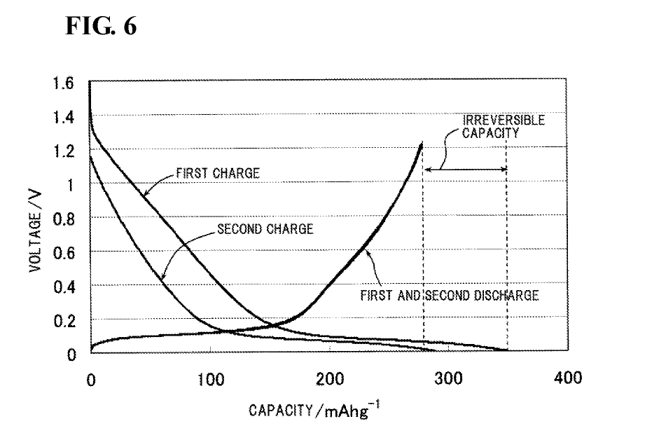

FIG. 6 illustrates exemplary charge-discharge curves of a half cell including an electrode containing hard carbon serving as an active material and a metallic sodium electrode serving as a counter electrode. Here, the hard carbon in the electrode is not pre-doped with sodium ions. In FIG. 6, the vertical axis represents the potential of the electrode containing hard carbon (hereinafter, also referred to simply as a “hard carbon electrode”) with respect to metallic sodium (hereinafter, the potential of the electrode is also referred to simply as an “electrode potential”). In FIG. 6, during the first charge, the potential of the hard carbon electrode drops steeply from 1.6 V and drops linearly from about 1.3 V to about 0.3 V at a certain gradient. When the electrode potential is 0.3 V or less, the electrode potential drops in a relatively flat curve. When the capacity of the hard carbon electrode per unit mass (capacity density) is about 350 mAh/g, the electrode potential converges to 0 V, and the battery is in a fully charged state.

During the first discharge, the electrode potential gradually increases in a flat curve to about 0.3 V and increases linearly from 0.3 V to about 0.7 V at a certain gradient. The discharge curve has a slightly increased gradient at an electrode potential of about 0.7 V to about 1.2 V. The electrode potential increases to substantially about 1.2 V during the discharge, and the battery is in a completely discharged state. At this time, the hard carbon electrode has a capacity density of about 280 mAh/g. A difference in capacity density between the fully charged state at the first charge and the completely discharged state at the first discharge is defined as the irreversible capacity of the hard carbon electrode (or active material).

At the second charge, a fully charged state is provided at a capacity density comparable to the capacity density in the completely discharged state at the first discharge, and the battery exhibits substantially no irreversible capacity. The discharge curve at the second discharge has substantially the same shape as that of the discharge curve at the first discharge.

As illustrated in FIG. 6, various charge reactions occur easily in a voltage range where a large change in electrode potential during charging is observed. Thus, in the case where the hard carbon electrode is used as a negative electrode of a sodium molten salt battery, when a molten salt electrolyte contains impurities and/or cations other than sodium ions, they are irreversibly reacted with hard carbon. Even if they are irreversibly reacted with hard carbon and/or they are reversibly intercalated, a certain charge reaction is less likely to occur. In particular, many ions are present in the molten salt electrolyte, compared with an organic electrolytic solution. Thus, the effects of the impurities and/or the cations other than sodium ions are significantly increased in the voltage range as described above. It is therefore difficult to stabilize the voltage and the capacity of the sodium molten salt battery.

In an embodiment of the present invention, the negative electrode active material is pre-doped with sodium ions in an amount such that the potential of the negative electrode at a SOC of 0% is 0.7 V or less (or 0.6 V or less) and particularly 0.3 V or less or 0.1 V or less with respect to metallic sodium. As a result, charging and discharging are less likely to be performed or are avoided in a voltage range where the battery is susceptible to the effects of impurities and/or cations other than sodium ions. This stabilizes the voltage of the battery, thereby leading to the stabilization of the capacity of the battery. The negative electrode active material is pre-doped with sodium ions in an amount more than the irreversible capacity, thus increasing the operating voltage of the battery and improving the cycle properties.

The pre-doping amount of sodium ions is, for example, 6 parts by mass or more, preferably 10 parts by mass or more, and more preferably 15 parts by mass or more with respect to 100 parts by mass of the negative electrode active material. The pre-doping amount is, for example, 25 parts by mass or less and preferably 20 parts by mass or less with respect to 100 parts by mass of the negative electrode active material. These lower limits may be freely combined with these upper limits. The pre-doping amount may be in the range of, for example, 6 to 25 parts by mass, 10 to 20 parts by mass, or 15 to 20 parts by mass with respect to 100 parts by mass of the negative electrode active material. When the pre-doping amount is within the range as described above, the effects of stabilizing the voltage and the capacity of the battery are more easily provided.

The pre-doping amount is, for example, 1.3 or more times, preferably 1.5 or more times, and more preferably 1.8 or more times (particularly 2 or more times) the irreversible capacity of the negative electrode active material when SOC is 0%. In the case where the pre-doping amount is set to the range with respect to the irreversible capacity of the negative electrode active material, charging and discharging are less likely to be performed or are avoided in a voltage range where the battery is susceptible to the effects of impurities, thereby further facilitating the stabilization of the voltage and the capacity of the battery. The upper limit of the pre-doping amount of sodium ions at a SOC of 0% is not particularly limited and is preferably 3.5 or less times the irreversible capacity of the negative electrode active material from the viewpoint of inhibiting the deposition of sodium.

The irreversible capacity of the negative electrode active material varies depending on the amount of water in the negative electrode active material (or the negative electrode or the battery). Thus, the value of the irreversible capacity of the negative electrode active material serving as an index of the pre-doping amount of sodium ions is desirably measured under dry conditions. The amount of water in each of the positive electrode and the negative electrode at the time of the measurement of the irreversible capacity is preferably, for example, 100 ppm or less. The amount of water in the positive electrode and the negative electrode may be measured by, for example, a Karl Fischer method. The amount of water in the positive electrode and the negative electrode may be reduced by, for example, drying the positive electrode and the negative electrode under heating (for example, at 150° C. to 200° C.) (for example, drying under reduced pressure).

The irreversible capacity of hard carbon is relatively large. Thus, in the case where the negative electrode active material containing hard carbon is used, an increase in the amount of the negative electrode active material charged in the battery increases the irreversible capacity. This facilitates a reduction in the capacity of the negative electrode and a reduction in the operating voltage of the battery. To avoid the problem, it is conceivable that the negative electrode active material is pre-doped with sodium ions in an amount corresponding to the irreversible capacity of the negative electrode active material. However, even if the negative electrode active material is pre-doped with sodium ions in an amount corresponding to the irreversible capacity, when the amount of the negative electrode active material charged is increased, a reduction in the operating voltage of the battery is not inhibited.

In contrast, in an embodiment of the present invention, the negative electrode active material is pre-doped with sodium ions in such a manner that the potential of the negative electrode at a SOC of 0% is 0.7 V or less. It is thus possible to inhibit a reduction in the capacity of the negative electrode and/or a reduction in the operating voltage of the battery even if the amount of the negative electrode active material charged is increased. Furthermore, the ratio of the reversible capacity of the negative electrode to the reversible capacity of the positive electrode can be increased. Thus, even in the case of overcharge, the deposition of metallic sodium on a surface of the negative electrode is inhibited, thereby improving the cycle properties and/or the safety of the battery.

A reduction in the capacity of the negative electrode and/or a reduction in the operating voltage of the battery due to the detachment of deposited metallic sodium is more effectively inhibited by controlling the ratio of the reversible capacity of the negative electrode to the reversible capacity of the positive electrode, i.e., Cₙ/Cₚ. The Cₙ/Cₚ ratio is, for example, 0.85 or more, preferably 1.2 or more, and more preferably 1.4 or more or 1.6 or more. The Cₙ/Cₚ ratio is, for example, 2.8 or less, preferably 2.5 or less, and more preferably 2.3 or less. These lower limits may be freely combined with these upper limits. The Cₙ/Cₚ ratio may be in the range of, for example, 0.85 to 2.8, 1.2 to 2.5, or 1.4 to 2.5. A higher Cₙ/Cₚ ratio is liable to cause the operating voltage of the battery to decrease markedly. However, the pre-doping of the negative electrode active material with sodium ions in a specific amount effectively inhibits the reduction in the capacity of the negative electrode and/or the reduction in the operating voltage of the battery even at a relatively high Cn/Cp ratio of 1.2 or more or 1.4 or more.

The negative electrode (specifically, a negative electrode mixture) may contain, for example, a binder and/or a conductive assistant as an optional component, in addition to the negative electrode active material.

The binder serves to bond active material particles together and fix the active material to a current collector. Examples of the binder include fluororesins, such as polytetrafluoroethylene, tetrafluoroethylene-hexafluoropropylene copolymers, and polyvinylidene fluoride; polyamide resins, such as aromatic polyamide; polyimide resins, such as polyimide (e.g., aromatic polyimide) and polyamide-imide; rubbery polymers, such as styrene rubber, e.g., styrene-butadiene rubber, and butadiene rubber; and cellulose derivatives (e.g., cellulose ethers), such as carboxymethylcellulose and salts thereof (e.g., Na salts).

The amount of the binder is preferably 1 to 10 parts by mass and more preferably 3 to 5 parts by mass with respect to 100 parts by mass of the active material.

Examples of the conductive assistant include carbonaceous conductive assistants, such as carbon black and carbon fibers; and metal fibers. The amount of the conductive assistant may be appropriately selected from, for example, 0.1 to 15 parts by mass with respect to 100 parts by mass of the active material and may be in the range of 0.3 to 10 parts by mass.

The negative electrode may be formed by fixing the negative electrode mixture to a surface of the negative electrode current collector. Specifically, the negative electrode may be formed by, for example, applying a negative electrode mixture slurry containing the negative electrode active material to the surface of the negative electrode current collector, drying the slurry, and, optionally, performing rolling.

The negative electrode mixture slurry is prepared by dispersing the negative electrode active material and, as an optional component, the binder and/or the conductive assistant in a dispersion medium. Examples of the dispersion medium include ketones, such as acetone; ethers, such as tetrahydrofuran; nitriles, such as acetonitrile; amides, such as dimethylacetamide; and N-methyl-2-pyrrolidone. These dispersion media may be used separately or in combination of two or more thereof.

The pre-doping of the negative electrode active material with sodium ions may be performed before the assembly of the battery or at the time of the assembly of the battery. In the case where the pre-doping is performed before the assembly of the battery, for example, the pre-doping of sodium ions may be performed by producing a half cell including the negative electrode produced as described above and a counter electrode composed of metallic sodium, the negative electrode being used as a positive electrode, and performing discharging in an electrolyte to occlude sodium ions. The negative electrode pre-doped with sodium ions may be used for the assembly of the sodium molten salt battery.

In the case where the pre-doping of sodium ions is performed at the time of the assembly of the battery, for example, the positive electrode, the negative electrode, and the molten salt electrolyte are placed in a battery case while sodium metal foil is bonded to a surface of the negative electrode or the negative electrode is electrically connected to a sodium electrode, thereby assembling the battery. By short-circuiting the negative electrode and the sodium metal foil or the sodium electrode in the battery, the negative electrode active material can be doped with sodium ions from the sodium metal foil or the sodium electrode. At the time of doping, a current may be passed, as needed.

In the case where the pre-doping of sodium ions is performed at the time of the assembly of the battery, the potential of the negative electrode and the pre-doping amount may be directly measured for the pre-doped negative electrode. The pre-doping amount may be determined on the basis of the pre-doping mass of sodium ions. Alternatively, the pre-doping amount may be determined in terms of the capacity of the negative electrode per unit mass. In the case where the pre-doping of sodium ions is performed at the time of the assembly of the battery, after the pre-doping is performed in the battery, the potential of the negative electrode and the pre-doping amount may be measured in the same way as above for the negative electrode disassembled from the battery.

### (Positive Electrode)

The positive electrode contains a positive electrode active material. Preferably, the positive electrode active material electrochemically occludes and releases sodium ions. The positive electrode includes a positive electrode current collector and contains the positive electrode active material immobilized on a surface of the positive electrode current collector. The positive electrode may contain, for example, a binder and a conductive assistant, as optional components.

As with the negative electrode current collector, for example, metal foil, a nonwoven fabric composed of metal fibers, and/or a porous metal sheet is used as the positive electrode current collector. Examples of a metal preferably contained in the positive electrode current collector include, but are not limited to, aluminum and aluminum alloys because they are stable at a positive electrode potential. The thickness of the current collector may be selected from the same range as used for the negative electrode current collector.

As the positive electrode active material, a compound containing sodium and a transition metal (for example, a transition metal, e.g., Cr, Mn, Fe, Co, or Ni, in the fourth period of the periodic table) is preferably used in view of thermal stability and electrochemical stability. The compound may contain one or two or more transition metals. At least one of sodium and the transition metal may be partially replaced with a main-group metal element, such as Al.

The positive electrode active material preferably contains a transition metal compound, such as a sodium-containing transition metal compound. The transition metal compound is not particularly limited and is preferably a compound having a layer structure in which sodium is intercalated into and deintercalated from interlayer portions.

Among the transition metal compounds, examples of sulfides include transition metal sulfides, such as TiS₂ and FeS₂; sodium-containing transition metal sulfides, such as NaTiS₂. Examples of oxides include sodium-containing transition metal oxides, such as NaCrO₂, NaNi_{0.5}Mn_{0.5}O₂, NaMn_{1.5}Ni_{0.5}O₄, NaFeO₂, NaFeₓ₁(Ni_{0.5}Mn_{0.5})₁₋ₓ₁O₂ (0<x1<1), Na_{2/3}Fe_{1/3}Mn_{2/3}O₂, NaMnO₂, NaNiO₂, NaCoO₂, and Na_{0.44}MnO₂. Examples of inorganic acid salts include sodium transition metal oxoates, such as sodium transition metal silicates (e.g., Na₆Fe₂Si₁₂O₃₀, Na₂Fe₅Si₁₂O₃₀, Na₂Fe₂Si₆O₁₈, Na₂MnFeSi₆O₁₈, and Na₂FeSiO₆), sodium transition metal phosphates, sodium transition metal fluorophosphates (e.g., Na₂FePO₄F and NaVPO₄F), and sodium transition metal borates (e.g., NaFeBO₄ and Na₃Fe₂(BO₄)₃). Examples of sodium transition metal phosphates include NaFePO₄, NaM¹PO₄, Na₃Fe₂(PO₄)₃, Na₂FeP₂O₇, and Na₄M¹₃ (PO₄)₂P₂O₇, wherein M¹ represents at least one selected from the group consisting of Ni, Co, and Mn. Examples of halides include sodium transition metal fluorides, such as Na₃FeF₆, NaMnF₃, and Na₂MnF₆.

These positive electrode active materials may be used alone or in combination of two or more.

Among the transition metal compounds, at least one selected from the group consisting of sodium-containing transition metal compounds, such as sodium chromite (NaCrO₂) and sodium iron manganese oxide (Na_{2/3}Fe_{1/3}Mn_{2/3}O₂) is preferred.

Cr or Na of sodium chromite may be partially replaced with another element. Fe, Mn, or Na of sodium iron manganese oxide may be partially replaced with another element. These substitution products may be included in sodium chromite or sodium iron manganese oxide. For example, Na₁₋ₓ₂M²ₓ₂Cr_{1-y1}M³_{y1}O₂ (0≦x2≦2/3, 0≦y1≦2/3, and M² and M³ each independently represent a metal element other than Cr or Na, and at least one selected from the group consisting of, for example, Ni, Co, Mn, Fe, and Al) and/or Na_{2/3-x3}M⁴ₓ₃Fe_{1/3-y2}Mn_{2/3-z1}M⁵y_{2+z1}O₂ (0≦x3≦1/3, 0≦y2≦1/3, 0≦z1≦1/3, and M⁴ and M⁵ each independently represent a metal element other than Fe, Mn, or Na, and at least one selected from the group consisting of, for example, Ni, Co, Al, and Cr) may be used, wherein M² and M⁴ each represent an element that occupies Na sites, M³ represents an element that occupies Cr sites, and M⁵ represents an element that occupies Fe or Mn sites.

The binder and the conductive assistant may be appropriately selected from those exemplified for the negative electrode. The amounts of the binder and the conductive assistant with respect to the active material may also be appropriately selected from those exemplified for the negative electrode.

As with the case of the negative electrode, the positive electrode may be formed by applying a positive electrode mixture slurry in which the positive electrode active material and, optionally, the binder and/or the conductive assistant are dispersed in a dispersion medium to a surface of the positive electrode current collector, drying the slurry, and optionally performing rolling. The dispersion medium may be appropriately selected from those exemplified for the negative electrode.

### (Separator)

The separator serves to physically isolate the positive electrode from the negative electrode to prevent an internal short circuit.

The separator is composed of a porous material. The pores are filled with the electrolyte. To achieve a cell reaction, the separator has sodium ion permeability.

As the separator, for example, a microporous membrane composed of a resin and/or a nonwoven fabric may be used. The separator may be formed of a microporous membrane layer or a nonwoven fabric layer alone, or may be formed of a multilayer component having a plurality of layers with different compositions and/or forms. Examples of the multilayer component include multilayer components each having a plurality of resin porous layers with different compositions; and multilayer components each having a microporous membrane and a nonwoven fabric layer.

The material of the separator may be selected in consideration of the operating temperature of the battery. Examples of a resin contained in fibers constituting the microporous membrane or the nonwoven fabric include polyolefin resins, such as polyethylene, polypropylene, and ethylene-propylene copolymers; polyphenylene sulfide resins, such as polyphenylene sulfide and polyphenylene sulfide ketone; polyamide resins, such as aromatic polyamide resins (e.g., aramid resins); and polyimide resins.

These resins may be used alone or in combination of two or more. The fibers constituting the nonwoven fabric may be inorganic fibers, such as glass fibers. The separator is preferably composed of at least one selected from the group consisting of glass fibers, polyolefin resins, polyamide resins, and polyphenylene sulfide resins.

The separator may contain an inorganic filler. Examples of the inorganic filler include ceramics (e.g., silica, alumina, zeolite, and titania), talc, mica, and wollastonite. The inorganic filler is preferably in the form of particles or fibers. The separator has an inorganic filler content of, for example, 10% to 90% by mass and preferably 20% to 80% by mass.

The thickness of the separator is not particularly limited and may be selected in the range of, for example, about 10 to about 300 μm. In the case where the separator is formed of a microporous membrane, the separator preferably has a thickness of 10 to 100 μm and more preferably 20 to 50 μm. In the case where the separator is formed of a nonwoven fabric, the separator preferably has a thickness of 50 to 300 μm and more preferably 100 to 250 μm.

### (Molten Salt Electrolyte)

The molten salt electrolyte contains at least sodium ions serving as carrier ions.

The molten salt electrolyte needs to have ionic conductivity and thus contains ions (cations and anions) serving as charge carriers in a charge-discharge reaction in the molten salt battery. More specifically, the molten salt electrolyte contains a salt of a cation and an anion. In an embodiment of the present invention, the molten salt electrolyte needs to have sodium ion conductivity and thus contains a salt (first salt) of a sodium ion (first cation) and an anion (first anion).

As the first anion, a bis(sulfonyl)amide anion is preferred. Examples of the bis(sulfonyl)amide anion include bis(fluorosulfonyl)amide anion [such as bis(fluorosulfonyl)amide anion (N(SO₂F)₂⁻)], a (fluorosulfonyl)(perfluoroalkylsulfonyl)amide anion [such as a (fluorosulfonyl)(trifluoromethylsulfonyl)amide anion ((FSO₂)(CF₃SO₂)N⁻)], and a bis(perfluoroalkylsulfonyl)amide anion [such as a bis(trifluoromethylsulfonyl)amide anion (N(SO₂CF₃)₂⁻) and a bis(pentafluoroethylsulfonyl)amide anion (N(SO₂C₂F₅)₂⁻)]. The number of carbon atoms of the perfluoroalkyl group is, for example, 1 to 10, preferably 1 to 8, more preferably 1 to 4, and particularly preferably 1, 2, or 3.

Examples of the first anion which is preferred include a bis(fluorosulfonyl)amide anion (FSA⁻); a(fluorosulfonyl)(perfluoroalkylsulfonyl)amide anion such as a (fluorosulfonyl)(trifluoromethylsulfonyl)amide anion; and bis(perfluoroalkylsulfonyl)amide anions (PFSA⁻), such as a bis(trifluoromethylsulfonyl)amide anion (TFSA⁻) and a bis(perfluoroethylsulfonyl)amide anion. As the first salt, for example, a salt (NaFSA) of a sodium ion and FSA⁻ or a salt (NaTFSA) of a sodium ion and TFSA⁻ is particularly preferred. A single type of first salt may be used alone. Two or more types of first salts may be used in combination.

The electrolyte melts at a temperature equal to or higher than the melting point into an ionic liquid that exhibits sodium ion conductivity, thereby operating the molten salt battery. To operate the battery at an appropriate temperature in view of cost and its usage environment, the electrolyte preferably has a lower melting point. To reduce the melting point of the electrolyte, preferably, the molten salt electrolyte further contains a second salt of a cation (second cation) other than the sodium ion and an anion (second anion), in addition to the first salt.

Examples of the second cation include inorganic cations other than a sodium ion and organic cations such as organic onium cations.

Examples of the inorganic cations include metallic cations, such as alkali metal cations other than a sodium ion (e.g., a lithium ion, a potassium ion, a rubidium ion, and a cesium ion), and alkaline-earth metal cations (e.g., a magnesium ion and a calcium ion); and ammonium cations.

Examples of organic onium cations include cations derived from aliphatic amines, alicyclic amines, and aromatic amines (such as quaternary ammonium cations); nitrogen-containing onium cations, such as cations having nitrogen-containing heterocycles (i.e., cations derived from cyclic amines); sulfur-containing onium cations; and phosphorus-containing onium cations.

Examples of quaternary ammonium cations include tetraalkylammonium cations (e.g., tetraC₁₋₁₀alkylammonium cations), such as a tetramethylammonium cation, an ethyltrimethylammonium cation, a hexyltrimethylammonium cation, a tetraethylammonium cation (TEA⁺), and a triethylmethylammonium cation (TEMA⁺).

Examples of sulfur-containing onium cations include tertiary sulfonium cations, such as trialkylsulfonium cations (for example, triC₁₋₁₀alkylsulfonium cations), e.g., a trimethylsulfonium cation, a trihexylsulfonium cation, and a dibutylethylsulfonium cation.

Examples of phosphorus-containing onium cations include quaternary phosphonium cations, such as tetraalkylphosphonium cations (for example, tetraC₁₋₁₀alkylphosphonium cations), e.g., a tetramethylphosphonium cation, a tetramethylphosphonium cation, and a tetraoctylphosphonium cation; and alkyl(alkoxyalkyl)phosphonium cations (for example, triC₁₋₁₀alkyl(C₁₋₅alkoxyC₁₋₅alkyl)phosphonium cations), such as a triethyl(methoxymethyl)phosphonium cation, a diethylmethyl(methoxymethyl)phosphonium cation, and a trihexyl(methoxyethyl)phosphonium cation. In an alkyl(alkoxyalkyl)phosphonium cation, the total number of the alkyl groups and the alkoxyalkyl groups attached to a phosphorus atom is 4. The number of the alkoxyalkyl groups is preferably 1 or 2.

The number of carbon atoms of an alkyl group attached to the nitrogen atom of a quaternary ammonium cation, the sulfur atom of a tertiary sulfonium cation, or the phosphorus atom of a quaternary phosphonium cation is preferably 1 to 8, more preferably 1 to 4, and particularly preferably 1, 2, or 3.

Examples of the nitrogen-containing heterocyclic skeleton of an organic onium cation include 5- to 8-membered heterocycles, such as pyrrolidine, imidazoline, imidazole, pyridine, and piperidine, each having 1 or 2 nitrogen atoms serving as constituent atoms of the ring; and 5- to 8-membered heterocycles, such as morpholine, each having 1 or 2 nitrogen atoms and another heteroatom (an oxygen atom, a sulfur atom, or the like) serving as constituent atoms of the ring.

The nitrogen atom serving as a constituent atom of the ring may be attached to an organic group, such as an alkyl group, serving as a substituent. Examples of the alkyl group include alkyl groups, such as a methyl group, an ethyl group, a propyl group, and an isopropyl group, each having 1 to 10 carbon atoms. The number of carbon atoms of the alkyl group is preferably 1 to 8, more preferably 1 to 4, and particularly preferably 1, 2, or 3.

Among nitrogen-containing organic onium cations, in particular, a quaternary ammonium cation and a cation having pyrrolidine, pyridine, or imidazole serving as a nitrogen-containing heterocyclic skeleton are preferred. In an organic onium cation having a pyrrolidine skeleton, two alkyl groups described above are preferably attached to one nitrogen atom included in the pyrrolidine ring. In an organic onium cation having a pyridine skeleton, one alkyl group described above is preferably attached to one nitrogen atom included in the pyridine ring. In an organic onium cation having an imidazole skeleton, one alkyl group described above is preferably attached to each of the two nitrogen atoms included in the imidazole ring.

Specific examples of the organic onium cation having a pyrrolidine skeleton include a 1,1-dimethylpyrrolidinium cation, a 1,1-diethylpyrrolidinium cation, a 1-ethyl-1-methylpyrrolidinium cation, a 1-methyl-1-propylpyrrolidinium cation (MPPY⁺), a 1-butyl-1-methylpyrrolidinium cation (MBPY⁺), and a 1-ethyl-1-propylpyrrolidinium cation. Of these, in particular, pyrrolidinium cations, such as MPPY⁺ and MBPY⁺, each having a methyl group and an alkyl group with 2 to 4 carbon atoms are preferred because of their high electrochemical stability.

Specific examples of the organic onium cation having a pyridine skeleton include 1-alkylpyridinium cations, such as a 1-methylpyridinium cation, a 1-ethylpyridinium cation, and a 1-propylpyridinium cation. Of these, pyridinium cations each having an alkyl group with 1 to 4 carbon atoms are preferred.

Specific examples of the organic onium cation having an imidazole skeleton include a 1,3-dimethylimidazolium cation, a 1-ethyl-3-methylimidazolium cation (EMI⁺), a 1-methyl-3-propylimidazolium cation, a 1-butyl-3-methylimidazolium cation (BMI⁺), a 1-ethyl-3-propylimidazolium cation, and a 1-butyl-3-ethylimidazolium cation. Of these, imidazolium cations, such as EMI⁺ and BMI⁺, each having a methyl group and an alkyl group with 2 to 4 carbon atoms are preferred.

As the second cation, an organic cation is preferred. In particular, an organic onium cation having a pyrrolidine skeleton or imidazole skeleton is preferred.

In the case where the second cation is an organic cation, the melting point of the molten salt electrolyte is easily reduced. However, in the case where the molten salt electrolyte contains an organic cation, the organic cation itself or a decomposition product (such as an ion) of the organic cation may be irreversibly reacted with hard carbon to reduce the negative electrode capacity. In the foregoing embodiment of the present invention, by reducing the potential of the negative electrode by the pre-doping of sodium ions, even if the molten salt electrolyte containing an organic cation is used, a reduction in negative electrode capacity is inhibited, thereby stabilizing the cycle properties.

As the second anion, a bis(sulfonyl)amide anion is preferred. The bis(sulfonyl)amide anion may be appropriately selected from the anions exemplified as the first anions.

Specific examples of the second salt include a salt of a potassium ion and FSA⁻ (KFSA), a salt of potassium ion and TFSA⁻ (KTFSA), a salt of MPPY⁺ and FSA⁻ (MPPYFSA), a salt of MPPY⁺ and TFSA⁻ (MPPYTFSA), a salt of EMI⁺ and FSA⁻ (EMIFSA), and a salt of EMI⁺ and TFSA⁻ (EMITFSA). A single type of second salt may be used alone. Two or more types of second salts may be used in combination.

The molar ratio of the first salt to the second salt (=first salt:second salt) may be appropriately selected from the ranges of, for example, 1:99 to 99:1 and preferably 5:95 to 95:5, depending on types of salts. In the case where the second salt is a salt, such as a potassium salt, of an inorganic cation and the second anion, the molar ratio of the first salt to the second salt may be selected from the ranges of, for example, 30:70 to 70:30 and preferably 35:65 to 65:35. In the case where the second salt is a salt of an organic cation and the second anion, the molar ratio of the first salt to the second salt may be selected from the ranges of, for example, 1:99 to 60:40 and preferably 5:95 to 50:50.

The electrolyte used in the sodium molten salt battery may contain a known additive in addition to the foregoing sulfur-containing compound, as needed. Most of the electrolyte is preferably composed of the foregoing molten salts (ionic liquid (specifically, the first salt and the second salt)). The electrolyte has a molten salt content of, for example, 80% by mass or more (e.g., 80% to 100% by mass) and preferably 90% by mass or more (e.g., 90% to 100% by mass). In the case where the molten salt content is within the ranges described above, the heat resistance and/or flame retardancy of the electrolyte is easily enhanced.

The molten salt electrolyte contains many ions, compared with organic electrolytic solutions used for sodium ion secondary batteries or lithium ion secondary batteries. Thus, when hard carbon is used for the negative electrode, a side reaction due to charging or discharging occurs easily. In an embodiment of the present invention, by the pre-doping of the negative electrode active material with sodium ions in such a manner that the potential of the negative electrode is 0.7 V or less, charging and discharging are less likely to be performed in a voltage range where such a side reaction occurs easily, even though the electrolyte contains many ions. The concentration of cations in the molten salt electrolyte is, for example, 3.5 mol/L or more, preferably 4 mol/L or more, and more preferably 4.2 mol/L or more. The upper limit of the concentration of the cations in the molten salt electrolyte is, but not particularly limited to, for example, 6 mol/L or less.

In the case where the molten salt electrolyte contains the second cation, such as an organic cation, a side reaction due to charging or discharging occurs easily, so that the battery and/or capacity of the battery is liable to be affected by a side reaction in which the second cation such as an organic cation participates, caused by charging or discharging. However, in an embodiment of the present invention, by the pre-doping of the negative electrode active material with sodium ions in such a manner that the potential of the negative electrode is 0.7 V or less, the voltage and/or the capacity of the battery is more effectively stabilized, even if the molten salt electrolyte contains the second cation. The concentration of the second cation in the molten salt electrolyte is, for example, 2 mol/L or more, preferably 2.5 mol/L or more, and more preferably 3 mol/L or more. The concentration of the second cation in the molten salt electrolyte is, for example, less than 5 mol/L and preferably 4.7 mol/L or less. These lower limits may be freely combined with these upper limits. The concentration of the second cation may be in the range of, for example, 2 to 5 mol/L, 2.5 to 5 mol/L, or 3 to 4.7 mol/L.

The sodium molten salt battery is used in a state in which the positive electrode, the negative electrode, the separator arranged therebetween, and the molten salt electrolyte are housed in a battery case. The positive electrode and the negative electrode are stacked or wound with the separator provided therebetween to form an electrode group. The electrode group may be housed in the battery case. In the case where a battery case composed of a metal is used and where one of the positive electrode and the negative electrode is electrically connected to the battery case, part of the battery case may be used as a first external terminal. The remaining one of the positive electrode and the negative electrode is connected to a second external terminal leading to the outside of the battery case with a lead strip or the like in a state of being insulated from the battery case.

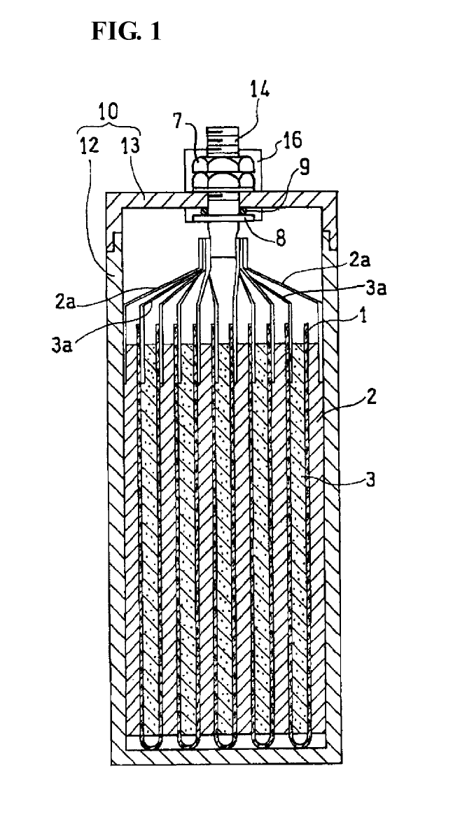

FIG. 1 is a longitudinal sectional view schematically illustrating a sodium molten salt battery.

A sodium molten salt battery includes a stacked electrode group, an electrolyte (not illustrated), and a prismatic aluminum battery case 10 that accommodates these components. The battery case 10 includes a case main body 12 having an open top and a closed bottom; and a lid member 13 that closes the top opening.

When the sodium molten salt battery is assembled, positive electrodes 2 and negative electrodes 3 are stacked with separators 1 provided therebetween to form an electrode group, and the electrode group is inserted into the case main body 12 of the battery case 10. Then a step of filling gaps between the separators 1, the positive electrodes 2, and the negative electrodes 3 constituting the electrode group with an electrolyte is performed by charging a molten salt into the case main body 12. Alternatively, the electrode group may be impregnated with the molten salt, and then the electrode group containing the molten salt may be housed in the case main body 12. The negative electrodes 3 may be pre-doped with sodium ions. For example, the negative electrodes 3 may be pre-doped with sodium ions by assembling a battery while metallic sodium foil is bonded to a surface of the negative electrodes 3 or the negative electrodes 3 is electrically connected to a sodium electrode, and then establishing a short circuit.

A safety valve 16 configured to release a gas to be generated inside when the internal pressure of the battery case 10 increases is provided in the middle of the lid member 13. An external positive electrode terminal 14 passing through the lid member 13 in a state of being electrically connected to the battery case 10 is provided on one side portion of the lid member 13 with respect to the safety valve 16. An external negative electrode terminal passing through the lid member 13 in a state of being electrically insulated from the battery case 10 is provided on the other side portion of the lid member 13.

The stacked electrode group includes the plural positive electrodes 2, the plural negative electrodes 3, and the plural separators 1 provided therebetween, each of the positive electrodes 2 and the negative electrodes 3 having a rectangular sheet shape. In FIG. 1, each of the separators 1 has a bag form so as to surround a corresponding one of the positive electrodes 2. However, the form of each separator is not particularly limited. The plural positive electrodes 2 and the plural negative electrodes 3 are alternately stacked in the stacking direction in the electrode group.

A positive electrode lead strip 2a may be arranged on an end portion of each of the positive electrodes 2. The positive electrode lead strips 2a of the plural positive electrodes 2 are bundled and connected to the external positive electrode terminal 14 provided on the lid member 13 of the battery case 10, so that the plural positive electrodes 2 are connected in parallel. Similarly, a negative electrode lead strip 3a may be arranged on an end portion of each of the negative electrodes 3. The negative electrode lead strips 3a of the plural negative electrodes 3 are bundled and connected to the external negative electrode terminal provided on the lid member 13 of the battery case 10, so that the plural negative electrodes 3 are connected in parallel. The bundle of the positive electrode lead strips 2a and the bundle of the negative electrode lead strips 3a are preferably arranged on left and right sides of one end face of the electrode group with a distance kept between the bundles so as not to come into contact with each other.

Each of the external positive electrode terminal 14 and the external negative electrode terminal is columnar and has a screw groove at least in the externally exposed portion. A nut 7 is engaged with the screw groove of each terminal, and is screwed to secure the nut 7 to the lid member 13. A collar portion 8 is arranged in a portion of each terminal inside the battery case. Screwing the nut 7 allows the collar portion 8 to be secured to the inner surface of the lid member 13 with a washer 9.

In an embodiment of the present invention, by the control of the pre-doping of the negative electrode active material with sodium ions, charging and discharging are less likely to be performed or are avoided in a voltage range where the battery is susceptible to the effects of impurities. The charge and discharge of the sodium molten salt battery may be usually controlled by a charge control unit and a discharge control unit in a charge-discharge system including the sodium molten salt battery. An embodiment of the present invention includes a charge-discharge system including the sodium molten salt battery, the charge control unit configured to control the charge of the sodium molten salt battery, and the discharge control unit configured to control the discharge of the sodium molten salt battery. The discharge control unit may include a loading device configured to consume power supplied from the sodium molten salt battery.

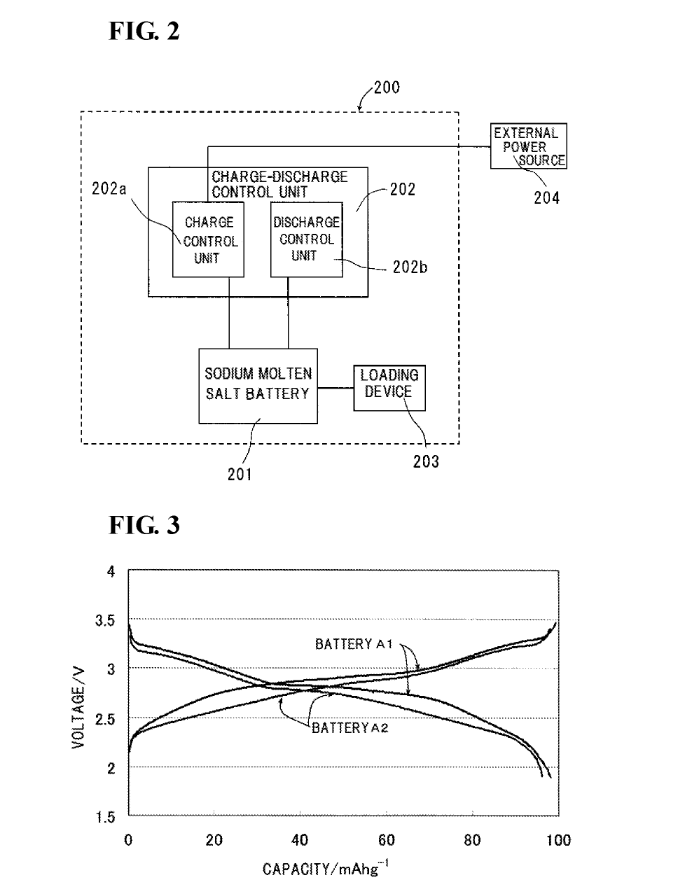

FIG. 2 is a block diagram schematically illustrating a charge-discharge system according to an embodiment of the present invention.

A charge-discharge system 200 includes a sodium molten salt battery 201, a charge-discharge control unit 202 configured to control the charge and discharge of the sodium molten salt battery 201, and a loading device 203 configured to consume power supplied from the sodium molten salt battery 201. The charge-discharge control unit 202 includes a charge control unit 202a configured to control, for example, a current and/or a voltage during the charging of the sodium molten salt battery 201 and a discharge control unit 202b configured to control, for example, a current and/or a voltage during the discharging of the sodium molten salt battery 201. The charge control unit 202a is connected to an external power source 204 and the sodium molten salt battery 201. The discharge control unit 202b is connected to the sodium molten salt battery 201. The loading device 203 is connected to the sodium molten salt battery 201.

### APPENDIX

Regarding the foregoing embodiments, the following appendixes are further disclosed.

### Appendix 1

A sodium molten salt battery includes a positive electrode containing a positive electrode active material, a negative electrode containing a negative electrode active material, a separator provided between the positive electrode and the negative electrode, and a molten salt electrolyte having sodium ion conductivity,

in which the negative electrode active material contains hard carbon and is pre-doped with sodium ions, and when the state of charge is 0%, the potential of the negative electrode is 0.7 V or less with respect to metallic sodium.

In the sodium molten salt battery, charging and discharging is avoided in a voltage range where the battery is susceptible to the effects of impurities. This stabilizes the voltage of the battery, thereby leading to the stabilization of the capacity of the battery. Furthermore, an irreversible reduction in the capacity of the negative electrode is inhibited, and the cycle properties are improved.

### Appendix 2

In the sodium molten salt battery described in Appendix 1, the molten salt electrolyte preferably contains cations containing a sodium ion (first cation), and the concentration of the cations in the molten salt electrolyte is preferably in the range of 3.5 to 6 mol/L. Even though the concentration of the cations is within the range, by the pre-doping of the negative electrode active material with sodium ions in such a manner that the potential of the negative electrode is 0.7 V or less at a SOC of 0%, charging and discharging are less likely to be performed or are avoided in a voltage range where a side reaction due to charging or discharging occurs easily.

### Appendix 3

In the sodium molten salt battery described in Appendix 2, preferably, the cations further contain an organic cation (second cation), and the concentration of the second cation in the molten salt electrolyte is preferably in the range of 2 to 5 mol/L. Even though the molten salt electrolyte contains the second cation in such a concentration, by the pre-doping of the negative electrode active material with sodium ions in such a manner that the potential of the negative electrode is 0.7 V or less, the voltage and/or the capacity of the battery is more effectively stabilized.

### EXAMPLES

The present invention will be specifically described below on the basis of examples and comparative examples. However, the present invention is not limited to these examples described below.

### Example 1

### (1) Production Positive Electrode

First, 85 parts by mass of NaCrO₂ (positive electrode active material), 10 parts by mass of acetylene black (conductive assistant), and 5 parts by mass of polyvinylidene fluoride (binder) were mixed together with N-methyl-2-pyrrolidone to prepare a positive electrode mixture slurry. The resulting positive electrode mixture slurry was applied to a surface of aluminum foil serving as a positive electrode current collector, dried, pressed, and vacuum-dried at 150° C. Punching was then performed to produce a disk-formed positive electrode (diameter: 12 mm, thickness: 85 μm). The mass of the positive electrode active material per unit area of the resulting positive electrode was 13.3 mg/cm². The reversible capacity of the positive electrode per unit mass of the positive electrode active material was 100 mAh/g.

### (2) Production of Negative Electrode

### (a) Production of Negative Electrode

First, 96 parts by mass of hard carbon (negative electrode active material) and 4 parts by mass of polyamide-imide (binder) were mixed together with N-methyl-2-pyrrolidone to prepare a negative electrode mixture slurry. The resulting negative electrode mixture slurry was applied to aluminum foil serving as a negative electrode current collector dried, pressed, and vacuum-dried at 200° C. Punching was then performed to produce a disk-formed negative electrode (diameter: 12 mm, thickness: 70 μm). The mass of the negative electrode active material per unit area of the resulting negative electrode was 5.4 mg/cm².

### (b) Measurement of Irreversible Capacity

A half cell was produced with the resulting negative electrode and a metallic sodium electrode (counter electrode). The irreversible capacity of the negative electrode active material was determined with the half cell as described below.

The half cell was fully charged at a constant current of 25 mA/g until a substantially no reduction in the potential of the negative electrode was observed. The potential of the negative electrode here was 0 V with respect to metallic sodium. The charge capacity of the negative electrode active material per unit mass was determined. Next, the battery was completely discharged at a constant current of 25 mA/g until a substantially no increase in the potential of the negative electrode was observed. The potential of the negative electrode here was 1.2 V with respect to metallic sodium. The discharge capacity of the negative electrode active material per unit mass was determined. From the charge capacity in a fully charged state and the discharge capacity in a completely discharged state, the irreversible capacity of the negative electrode active material (the irreversible capacity of the negative electrode active material per unit mass) was determined and found to be 70 mAh/g.

### (c) Pre-Doping of Sodium Ion

A half cell was produced with the negative electrode produced in item (a) and a metallic sodium electrode. The negative electrode was pre-doped with sodium ions from the metallic sodium electrode at 25 mA/g in an amount such that the potential of the negative electrode was 0.6 V at a SOC of 0%. At this time, the pre-doping amount of sodium ions was determined in terms of the capacity of the negative electrode active material per unit mass and found to be 1.5 times the irreversible capacity determined in item (b).

### (3) Assembly of Molten Salt Battery

The negative electrode pre-doped with sodium ions, the negative electrode being produced in item (2)(c), was arranged on the inside bottom portion of a case of a button-type battery. A separator was arranged on the negative electrode. The positive electrode produced in item (1) was arranged so as to face the negative electrode with a separator provided therebetween. A molten salt electrolyte was injected into the battery case. A lid member provided with an insulating gasket arranged at its circumference is fitted into an opening portion of the battery case, thereby producing a button-type sodium molten salt battery (battery A1). As the separator, a microporous membrane (thickness: 50 μm) composed of a heat-resistant polyolefin was used. As the molten salt electrolyte, a mixture of NaFSA and MPPYFSA in a molar ratio of 1:9 was used. The concentration of cations in the molten salt electrolyte was 4.5 mol/L. The concentration of MPPY⁺ was 4 mol/L. The ratio of the reversible capacity of the negative electrode to the reversible capacity of the positive electrode, i.e., Cₙ/Cₚ, was 1.

### (4) Evaluation

The sodium molten salt battery was heated to 60° C. The sodium molten salt battery was subjected to constant-current charge at a current rate of 1 C to 3.5 V and then constant-voltage charge (first charge) at 3.5 V. Subsequently, discharge (first discharge) was performed at a current rate of 1 C to 1.8 V. The discharge capacity of the battery at the first discharge (initial discharge capacity, that is, discharge capacity at the first cycle) was measured. Furthermore, the foregoing charge-discharge cycle was repeated until the discharge capacity of the battery reached 80% of the initial discharge capacity. At this time, the number of charge-discharge cycles was determined and was used as an index of the cycle properties.

### Example 2

A positive electrode was produced as in Example 1, except that the amount of the positive electrode mixture slurry applied was adjusted in such a manner that the mass of the positive electrode active material per unit area of the positive electrode was 6.7 mg/cm². A sodium molten salt battery (battery A2) was produced and evaluated as in Example 1, except that the resulting positive electrode was used. The ratio of the reversible capacity of the negative electrode to the reversible capacity of the positive electrode, i.e., Cₙ/Cₚ, was 2.

### Example 3

A negative electrode was produced as in Example 1, except that the amount of the negative electrode mixture slurry applied was adjusted in such a manner that the mass of the negative electrode active material per unit area of the negative electrode was 6.3 mg/cm² and except that the pre-doping of sodium ions was performed in an amount such that the potential of the negative electrode was 0.3 V at a SOC of 0%. A sodium molten salt battery (battery A3) was produced and evaluated as in Example 1, except that the resulting negative electrode was used. The pre-doping amount of sodium ions was determined in terms of the capacity the negative electrode active material per unit mass and found to be twice the irreversible capacity of the negative electrode active material. The ratio of the reversible capacity of the negative electrode to the reversible capacity of the positive electrode, i.e., Cₙ/Cₚ, was 1.

### Example 4

A positive electrode was produced as in Example 3, except that the amount of the positive electrode mixture slurry applied was adjusted in such a manner that the mass of the positive electrode active material per unit area of the positive electrode was 6.7 mg/cm². A sodium molten salt battery (battery A4) was produced and evaluated as in Example 3, except that the resulting positive electrode was used. The ratio of the reversible capacity of the negative electrode to the reversible capacity of the positive electrode, i.e., Cₙ/Cₚ, was 2.

### Comparative Example 1

A negative electrode was produced as in Example 1, except that the amount of the negative electrode mixture slurry applied was adjusted in such a manner that the mass of the negative electrode active material per unit area of the negative electrode was 4.7 mg/cm² and except that the pre-doping of sodium ions was performed in an amount such that the potential of the negative electrode was 0.9 V at a SOC of 0%. A sodium molten salt battery (battery B1) was produced and evaluated as in Example 1, except that the resulting negative electrode was used. The pre-doping amount of sodium ions was determined in terms of the capacity the negative electrode active material per unit mass and found to be comparable to the irreversible capacity of the negative electrode active material.

The ratio of the reversible capacity of the negative electrode to the reversible capacity of the positive electrode, i.e., Cₙ/Cₚ, was 1.

### Comparative Example 2

A positive electrode was produced as in Comparative example 1, except that the amount of the positive electrode mixture slurry applied was adjusted in such a manner that the mass of the positive electrode active material per unit area of the positive electrode was 6.7 mg/cm². A sodium molten salt battery (battery B2) was produced and evaluated as in Comparative example 1, except that the resulting positive electrode was used. The ratio of the reversible capacity of the negative electrode to the reversible capacity of the positive electrode, i.e., Cₙ/Cₚ, was 2.

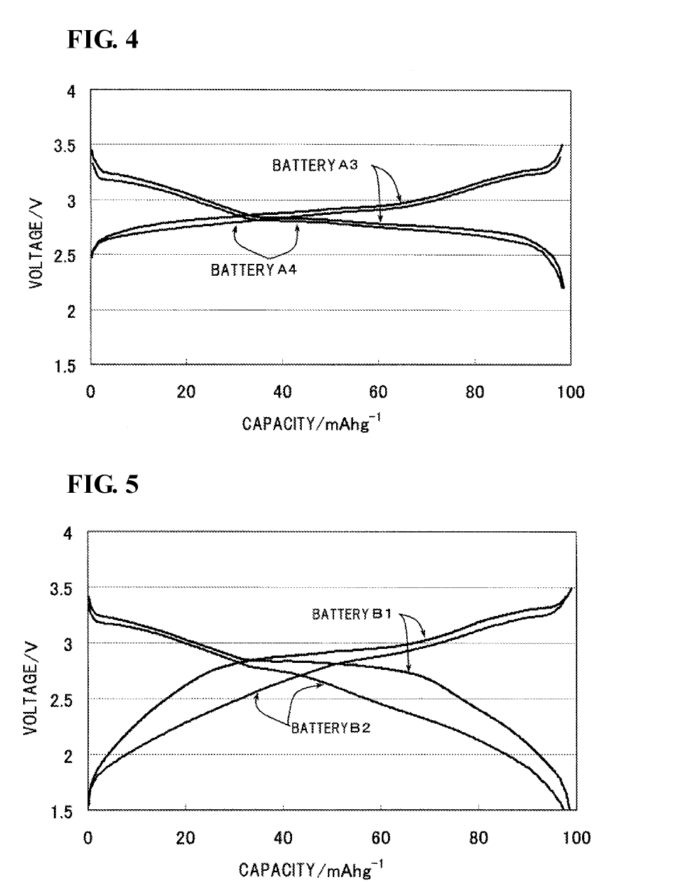

FIG. 3 illustrates charge-discharge curves of sodium molten salt batteries A1 and A2 at the first charge-discharge cycle. FIG. 4 illustrates charge-discharge curves of sodium molten salt batteries A3 and A4 at the first charge-discharge cycle. FIG. 5 illustrates charge-discharge curves of sodium molten salt batteries B1 and B2 at the first charge-discharge cycle. Table 1 lists the results of the cycle properties in the examples and the comparative examples. Batteries A1 to A4 are of the examples. Batteries B1 and B2 are of the comparative examples.

TABLE 1

| Battery | Number of cycles |
|---|---|
| A1 | 800 |
| A2 | 1000 |
| A3 | 1100 |
| A4 | 1400 |
| B1 | 600 |
| B2 | 800 |

As is illustrated in FIG. 5, in each of batteries B1 and B2 of the comparative examples in which the negative electrodes each pre-doped with sodium ions in such a manner that the potential of each of the negative electrodes was 0.9 V at a SOC of 0% were used, charge and discharge were performed in a voltage range where the gradient of the potential of the negative electrode was large. Thus, a side reaction due to charging or discharging occurred easily, so that the voltage and the capacity of the battery were not stabilized. In contrast, as illustrated in FIGS. 3 and 4, in each of batteries A1 to A4 of the examples, charge and discharge were performed in a voltage range where the potential of the negative electrode was relatively flat. Thus, the effect of a side reaction due to charging or discharging was reduced, so that the voltage and the capacity of the battery was stabilized. FIG. 5 demonstrates that a higher ratio of the reversible capacity of the negative electrode to the reversible capacity of the positive electrode is liable to lead to a greater reduction in the operating voltage of the battery. However, in the examples illustrated in FIGS. 3 and 4, by the pre-doping of the negative electrode active material with sodium ions, a reduction in the capacity of the negative electrode of the battery and a reduction in the operating voltage of the battery are effectively inhibited even at a high ratio of the reversible capacity of the negative electrode to the reversible capacity of the positive electrode.

As listed in Table 1, good cycle properties were provided in the examples, compared with the comparative examples. The reason for this is presumably that by the pre-doping of the negative electrode active material with sodium ions in such a manner that the potential of each of the negative electrode was a specific value, the negative electrode capacity in the battery was increased, thereby inhibiting the deposition of metallic sodium.

### INDUSTRIAL APPLICABILITY

According to an embodiment of the present invention, even in the case where hard carbon is used as the negative electrode active material, in the sodium molten salt battery, the battery voltage (and/or battery capacity) during charging and discharging is stabilized. Thus, the sodium molten salt battery is useful for, for example, large-scale power storage apparatuses for household and industrial use and power sources for electric vehicles and hybrid vehicles.

### REFERENCE SIGNS LIST

1 separator
2 positive electrode
2a positive electrode lead strip
3 negative electrode
3a negative electrode lead strip
7 nut
8 collar portion
9 washer
10 battery case
12 case main body
13 lid member
14 external positive electrode terminal
16 safety valve
200 charge-discharge system
201 sodium molten salt battery
202 charge-discharge control unit
202a charge control unit
202b discharge control unit
203 loading device
204 external power source

1. A sodium molten salt battery comprising:
a positive electrode containing a positive electrode active material, a negative electrode containing a negative electrode active material, a separator provided between the positive electrode and the negative electrode, and a molten salt electrolyte having sodium ion conductivity,
wherein the negative electrode active material contains hard carbon and is pre-doped with sodium ions, and
when the state of charge is 0%, the potential of the negative electrode is 0.7 V or less with respect to metallic sodium.

2. The sodium molten salt battery according to claim 1, wherein the molten salt electrolyte contains 80% by mass or more of an ionic liquid.

3. The sodium molten salt battery according to claim 1, wherein when the state of charge is 0%, the pre-doping amount of the sodium ions is 6 parts by mass or more with respect to 100 parts by mass of the negative electrode active material.

4. The sodium molten salt battery according to claim 1, wherein when the state of charge is 0%, the potential of the negative electrode is 0.3 V or less with respect to metallic sodium.

5. The sodium molten salt battery according to claim 1, wherein when the state of charge is 0%, the pre-doping amount of the sodium ions is equal to or more than twice the irreversible capacity of the negative electrode active material.

6. The sodium molten salt battery according to claim 2, wherein the ionic liquid contains a first salt of sodium ions and bis(sulfonyl)amide anions and a second salt of organic cations and bis(sulfonyl)amide anions.

7. The sodium molten salt battery according to any claim 1, wherein the ratio of the reversible capacity of the negative electrode to the reversible capacity of the positive electrode, i.e., Cₙ/Cₚ, is in the range of 0.85 to 2.8.

8. The sodium molten salt battery according to claim 1, wherein the ratio of the reversible capacity of the negative electrode to the reversible capacity of the positive electrode, i.e., Cₙ/Cₚ, is in the range of 1.4 to 2.5.
